(19) United States
(12) Patent Application Publication
(10) Pub. No.: US 2026/0000240 A1
(43) Pub. Date: Jan. 1, 2026

(54) COFFEE DRIP DEVICE WHICH SUPPLIES WATER ON BASIS OF SIZE OF MUFFIN REFERRING TO PUFFED FORM OF WET COFFEE POWDER

(71) Applicant: BNCR CO., LTD, Seongnam-si (KR)

(72) Inventor: Jeonghyun CHOI, Seongnam-si (KR)

(73) Assignee: BNCR CO., LTD, Seongnam-si (KR)

(21) Appl. No.: 18/729,663

(22) PCT Filed: Jul. 10, 2023
(86) PCT No.: PCT/KR2023/009739

§ 371 Date: Jul. 28, 2025

(30) Foreign Application Priority Data
Nov. 29, 2022 (KR) 10-2022-0163215
Mar. 29, 2023 (KR) 10-2023-0041513

(51) Int. Cl. A47J 31/52; A47J 31/10

(52) U.S. Cl. CPC A47J 31/525; A47J 31/10

(57) ABSTRACT

A coffee drip device is disclosed. The coffee drip device includes a water supplier configured to supply water to a dripper in which crushed coffee beans are received, an actuator configured to adjust a position of at least a portion of the water supplier such that a water supply point of the water supplier is changed, a camera configured to take a picture of at least a portion of coffee beans received in the dripper, and a controller. The controller performs a muffin forming step of forming a muffin composed of coffee beans having moisture and bubbles by supplying water to the dripper through the water supplier. Further, the controller recognizes a size of the muffin photographed through the camera. In the muffin forming step, the controller supplies water to the dripper through the water supplier while spirally changing the water supply point of the water supplier outward from a center through the actuator until the size of the muffin reaches a maximum water supply radius set in advance for the muffin forming step.

### TECHNICAL FIELD

The present disclosure relates to a coffee drip device that extracts coffee by automatically performing coffee drip and, in more detail, to a coffee drip device that sets a water supply amount and a water supply point on the basis of the size and shape of a muffin that means a puffed form of wet coffee powder.

### BACKGROUND ART

Processes of permeation, dissolution, and separation are three necessary processes in extraction of coffee. Water (hot water or cold water) soaks into coffee by permeating into appropriately crushed coffee particles, melting components of the coffee particles become a solution by dissolving into the water that is a solvent, and non-melted coffee particles and the solution are separated and extracted.

As coffee extraction methods, there are espresso, siphon, mocha port, French press, Turkish coffee extraction, Dutch coffee, hand drip, etc. The taste and aroma of coffee are greatly different, depending on extraction methods, so users select coffee extraction methods suiting their tastes and drink coffee.

The method that is favorably reviewed by consumers of those methods is hand drip. Since hand drip performs extraction through a filter paper, an impure taste is less and it is possible to greatly reduce components that increase the level of cholesterol such as cafestol contained in coffee.

Such hand drip can be classified again into an immersion type and a filtration type, and the filtration type makes less impure taste and miscellaneous scents in comparison to the immersion-type hand drip.

Water of 98% or more and dissolved solids within 2% are mixed in coffee extracted by filtration-type hand drip, the dissolve solids have components that have a good aroma, a sweet taste, a sour taste, a nutty aroma, chocolate scent and taste, appropriate body, and a good aftertaste that are positive tastes and scents, and there are also a bitter taste, a sense of astringency, a burnt smell, a tobacco smell like cigarette ash, a sour and astringent taste, etc. that are negative tastes.

The good tastes and aromas of coffee are determined by extracting well the components that have positive tastes in some cases, but it is considered to be more important to minimize extraction of the components that have negative tastes.

In particular, caffeine contained in coffee has beneficial effects for the human body, that is, effects such as an arousal effect, prevention of cancer, etc., promotion of metabolism, and help for blood circulation, but taking an excessive amount of coffee may cause side effects such as a headache, insomnia, and heat palpitation, and gastritis to people with a weak stomach, depending on people. Accordingly, it is required to extract excellent coffee that is helpful to health by decreasing components causing side effects while keeping tastes and aromas.

### DETAILED DESCRIPTION OF INVENTION

### Technical Problems

The present disclosure provides a coffee drip device that extracts coffee by supplying water to coffee bean powder.

The present disclosure provides a coffee drip device that can provide an optimal coffee taste on the basis of a separation drip by adjusting a water supply point and/or a water supply amount in accordance with the size and/or shape of a muffin.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

### Technical Solution

A coffee drip device according to an embodiment of the present disclosure includes a water supplier configured to supply water to a dripper in which crushed coffee beans are received, an actuator configured to adjust a position of at least a portion of the water supplier such that a water supply point of the water supplier is changed, a camera configured to take a picture of at least a portion of coffee beans received in the dripper, and a controller connected with the water supplier, the actuator, and the camera. The controller performs a muffin forming step of forming a muffin composed of coffee beans having moisture and bubbles by supplying water to the dripper through the water supplier, and recognizes a size of the muffin photographed through the camera. In the muffin forming step, the controller supplies water to the dripper through the water supplier while spirally changing the water supply point of the water supplier outward from the center through the actuator until the size of the muffin reaches a maximum water supply radius of the muffin forming step.

In the muffin forming step, the controller may supply water to the dripper through the water supplier while spirally changing the water supply point of the water supplier outward from the center through the actuator until the size of the muffin reaches a maximum water supply radius set in advance for the muffin forming step, and may supply water to the dripper through the water supplier while spirally changing the water supply point of the water supplier from the outside to the center through the actuator until the size of the muffin reaches a minimum water supply radius set in advance for the muffin forming step.

The coffee drip device may include a distance sensor configured to measure a height of the muffin. Further, the controller may perform a blooming step of securing a resting time of water supply for the formed muffin after the muffin forming step. In the blooming step, the controller may supply water to the dripper through the water supplier after a predetermined time passes from a point in time at which water supply is ended in the muffin forming step or a point in time at which the height of the muffin is the largest.

In this configuration, in the blooming step, the controller may set a path through which water sequentially drops on the basis of the shape of the muffin photographed through the camera, and may supply water to the dripper through the water supplier while changing the water supply point of the water supplier along the set path through the actuator.

Further, the coffee drip device may include a weight sensor configured to measure weight of a server configured to receive a coffee solution extracted through the dripper. In this configuration, the controller may recognize the amount of the coffee solution received in the server on the basis of the measured weight of the server. Further, in the blooming step, the controller may perform final standing-by of the blooming step when the amount of the coffee solution received in the server increases over a preset pre-extraction limit by primary water supply, may perform secondary water supply after standing by for a predetermined time when the amount of the coffee solution received in the server increases below the preset pre-extraction limit by the primary water supply, and may perform the final standing-by of the blooming step when the amount of the coffee solution received in the server increases over the preset pre-extraction limit by the secondary water supply.

Further, the controller may perform an extracting step for extracting a coffee solution after the blooming step. In this configuration, in the extracting step, the controller may supply water to the dripper through the water supplier at a point in time after a predetermined time from a point in time at which water supply is ended in the blooming step, or at a point in time at which the height of the muffin starts to decrease after the blooming step.

In this configuration, the controller may set a maximum water supply radius and a minimum water supply radius of the extracting step on the basis of the size of the muffin after the blooming step. Further, in the extracting step, the controller may supply water to the dripper through the water supplier while spirally changing the water supply point of the water supplier outward from the center through the actuator until the size of the muffin reaches the maximum water supply radius of the extracting step, and may supply water to the dripper through the water supplier while spirally changing the water supply point of the water supplier from the outside to the center through the actuator until the size of the muffin reaches the minimum water supply radius of the extracting step.

In this configuration, the controller may stop water supply when a water supply amount of the water supplier reaches a preset water supply amount in the extracting step.

Meanwhile, the coffee drip device may include a weight sensor configured to measure weight of a server configured to receive a coffee solution extracted through the dripper. In this configuration, the controller may recognize the amount of the coffee solution received in the server on the basis of the measured weight of the server. Further, the controller may stop water supply when the amount of the coffee solution received in the server reaches an extraction limit in the extracting step.

According to an embodiment of the present disclosure a method of controlling a coffee drip device including water supplier configured to supply water to a dripper in which crushed coffee beans are received, an actuator configured to adjust a position of at least a portion of the water supplier such that a water supply point of the water supplier is changed, and a camera configured to take a picture of at least a portion of coffee beans received in the dripper, includes: a muffin forming step of forming a muffin composed of coffee beans having moisture and bubbles by supplying water to the dripper through the water supplier by means of the coffee drip device; a blooming step of securing a resting time of water supply for the formed muffin by means of the coffee drip device; and an extracting step of extracting a coffee solution after the blooming step. The muffin forming step recognizes a size of the muffin photographed through the camera, and supplies water to the dripper through the water supplier while spirally changing the water supply point of the water supplier outward from a center through the actuator until the size of the muffin reaches a maximum water supply radius set in advance for the muffin forming step.

### Effect of Invention

A coffee drip device according to the present disclosure perform effective separation drip, to which a real-time state of a material is applied, by measuring the size and shape of a muffin that means a puffed state of wet coffee powder, thereby being able to perform delicate work of drip that automatically extracts excellent coffee even without help of a skilled professional.

### BRIEF DESCRIPTION OF THE DRAWING

FIG. 1A is a view illustrating the configuration of the external appearance of a coffee drip device according to an embodiment of the present disclosure.

FIG. 1B is a block diagram illustrating an electronic configuration of a coffee drip device including a camera in accordance with an embodiment of the present disclosure.

FIG. 1C is a block diagram illustrating an electronic configuration of a coffee drip device including a sensor unit in accordance with an embodiment of the present disclosure.

FIG. 2 is a flowchart illustrating the entirety of a coffee drip process of a coffee drip device according to an embodiment of the present disclosure.

FIG. 3 is an algorithm illustrating a muffin forming step that is performed by a coffee drip device according to an embodiment of the present disclosure.

FIG. 4 is an algorithm illustrating a blooming step that is performed by a coffee drip device according to an embodiment of the present disclosure.

FIG. 5 is an algorithm illustrating an extracting step that is performed by a coffee drip device according to an embodiment of the present disclosure.

FIG. 6 is a block diagram illustrating the detailed configuration of a coffee drip device according to various embodiments of the present disclosure.

### BEST MODE FOR CARRYING OUT THE INVENTION

Before describing the present disclosure in detail, the description method of the specification and the drawings are described.

First, terms that are used in the specification and claims were selected as general terms in consideration of the functions in various embodiments of the present disclosure. However, these terms may be changed, depending on intentions of those skilled in the art, or legal or technical construction, advent of new technologies, etc. Further, some terms were selected by the applicants at their option. Such terms may be construed as the meanings defined in the specification, and may be construed on the basis of the general content of the specification and the common technical common senses in the field unless specifically defined.

Further, the reference numerals or symbols described in the accompanying drawings of the specification indicate parts or components that perform substantially the same functions. The same reference numerals or symbols are used even in different embodiments for the convenience of describing and understanding. That is, even though all of components having the same reference numerals are shown in a plurality of drawings, the drawings do not mean one embodiment.

Further, terms including ordinal numbers such as “first” and “second” may be used in the specification and claims to discriminate components. Such ordinal numbers are used to distinguish the same or similar components from each other, and the meanings of terms should not be limited by such ordinal numbers. For example, the order of use or the order or arrangement of a component combined with an ordinal number should not be limited by the number. If necessary, ordinal numbers may be exchanged with each other.

Singular forms in the specification are intended to include plural forms unless the context clearly indicates otherwise. It will be further understood that the terms “comprises” or “composed of” used in this specification, specify the presence of stated features, steps, operations, components, parts, or a combination thereof, but do not preclude the presence or addition of one or more other features, numerals, steps, operations, components, parts, or a combination thereof.

In embodiments of the present disclosure, terms such as “module”, “unit”, and “part” are terms for indicting a component that performs at least one function or operation and the component may be implemented as hardware or software, or a combination of hardware and software. Further, a plurality of “modules”, “units”, and “parts” may be implemented as at least one processor by being integrated into at least one module or chip except for the case that they each need to be implemented as specific individual hardware.

Further, in embodiments of the present disclosure, when a component is connected with another component, it includes not only direct connection, but indirect connection through another component. Further, unless explicitly described otherwise, “comprising” any components will be understood to imply the inclusion of other components rather than the exclusion of any other components.

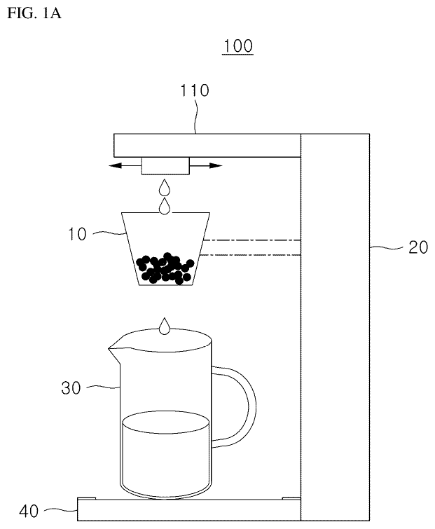

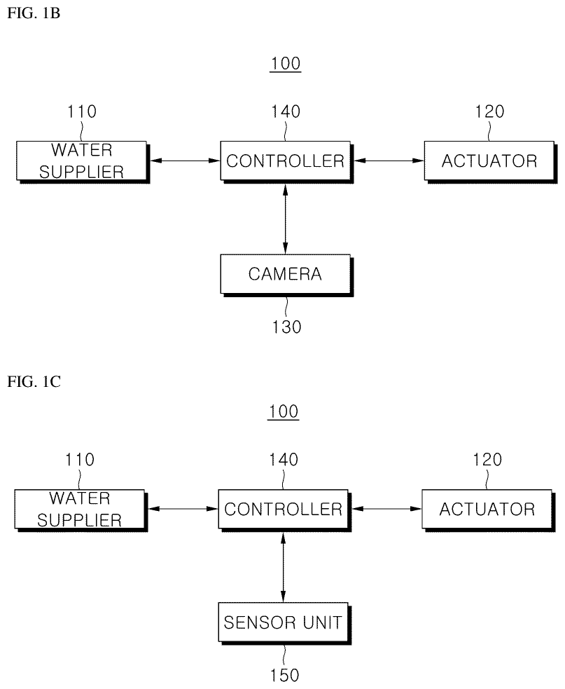

FIG. 1A is a view illustrating the configuration of the external appearance of a coffee drip device according to an embodiment of the present disclosure.

Referring to FIG. 1A, a coffee drip device 100 may include a dripper 10 for receiving the powder of crushed coffee beans, a body 20, a bed 40 for placing a server 30 for keeping an extracted coffee solution, etc.

In this configuration, the server 30 may be a part that is included in the coffee drip device 100 and can be attached and detached or may be a separate product not included in the coffee drip device 100.

The dripper 10 also may be a part that is included in the coffee drip device 100 and can be attached and detached or may be a separate product not included in the coffee drip device 100. In this case, the coffee drip device 100 may include at least one fixing member for fixing the dripper. Similar to common drippers, the dripper 10 of the present disclosure may have a shape that has a circular cross-section and of which the diameter of the circle decreases vertically down (e.g., a circular truncated cone, a circular cone, etc.).

Further, the coffee drip device 100 may include a water supplier 100 disposed over the dripper 10 to supply water to the dripper 10. The water supplier 110 may include at least one drain member, pump, etc. Further, a water tank for providing water to the water supplier 110 may be disposed in the body 20. The body 20 may include at least one heating unit for increasing the temperature of water in the water tank or water that is provided from the water tank to the water supplier 110.

FIG. 1B is a block diagram illustrating an electronic configuration of a coffee drip device according to an embodiment of the present disclosure.

Referring to FIG. 1B, the coffee drip device 100 may include a water supplier 110, an actuator 120, a camera 130, a controller 140, etc.

The water supplier 110 is a component for dropping water to a dripper and may include at least one mechanical component for bringing water such as a pump.

The actuator 120 is a component for adjusting the position of at least a portion of the water supplier such that a water supply point of the water supplier 110 is changed. The actuator 120 may include a motor, a compressor, a pump, etc., but is not limited thereto. In detail, the actuator 120 can change the position of an outlet of the water supplier 110 by applying a pulling force, a pushing force, a turning force, or the like to at least a portion of the water supplier 110. To this end, the actuator 110 may include at least one arm connected with the outlet, a rotary member, a gear, etc., but is not limited thereto.

The camera 130 is a component for taking a picture of the inside of the dripper 110 and may include at least one image sensor. The camera 130 may include an RGB camera, a depth camera, a Time of Flight (ToF) camera, a stereo camera, etc., but is not limited thereto.

As an embodiment, the camera 130 may be attached to the water supplier 110 shown in FIG. 1 to take a picture of the inside of the dripper from above, and in detail, may be attached to the bottom of the water supplier 110 and installed to face the dripper. However, the camera 130 may be fixed at a specific position regardless of movement of the outlet in the water supplier 110.

Alternatively, the camera 130 may be attached at the upper portion of the body or the section between the body and the water supplier 110 to take a picture of the inside of the dripper 10.

The controller 140 is a component for generally controlling the coffee drip device 100. The controller 140 may include at least one control circuit or processor. The processor may include a general-purpose processor such as a CPU, an AP, and a Digital Signal Processor (DSP), or a dedicated graphics processor such as a GPU and a Vision Processing Unit (VPU), or a dedicated AI processor such as an NPU. The processor is connected with a memory disposed in the separation drip device 100 and executes at least one instruction stored in the memory, thereby being able to control operation of the separation drip device 100 according to various embodiments of the present disclosure.

Meanwhile, referring to FIG. 1C, the coffee drip device 100 according to an embodiment of the present disclosure may include a sensor unit 150 for replacing the function of the camera 130 described above.

In detail, the sensor unit 140 may include at least one sensor for obtaining various items of information about the material (e.g., powder, a muffin, etc.) in the dripper 10. For example, the sensor unit may include a Lidar sensor, an ultrasonic sensor, etc.

As described above, the coffee drip device 100 according to the present disclosure can recognize the size, shape, etc. of a muffin through a camera, a Lidar sensor, etc., and apply the size, shape, etc. to a drip process, and operation of the drip device 100 is described hereafter in more detail fundamentally on the basis of the embodiment of FIG. 1B (including the camera 130).

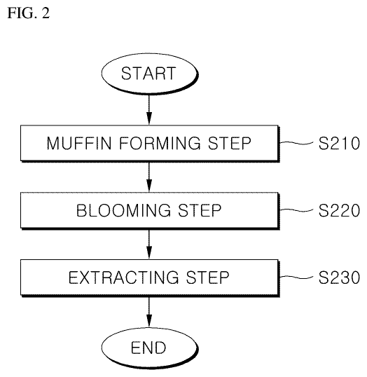

FIG. 2 is a flowchart illustrating the entirety of a coffee drip process of a coffee drip device according to an embodiment of the present disclosure.

Meanwhile, before performing the processes of FIG. 1, the controller 140 can perform various operations relating to initial settings. The following operations may be activated by receiving user's input that requests initial settings after crushed coffee beans are received in the dripper.

In detail, the controller 140 can recognize the center position of the dripper 10 photographed through the camera 130 and can find out the size (outer edge, radius, etc.) of the crushed coffee beans received in the dripper 10.

When at least one weight sensor for measuring the weight of coffee beans received in the dripper 10 is provided, the controller 140 can recognize the weight of the weight of received coffee beans.

In this case, the controller 140 can set a water supply amount in accordance with the weight of coffee beans received in the dripper 10. For example, an entire water supply amount, a water supply amount of a muffin forming step, a water supply amount of a blooming step, and a water supply amount of an extracting step can be separately set. As a detailed example, for coffee beans of 95 g, the water supply amount of the muffin forming step may be set as 25˜40 g, the water supply amount of the blooming step may be set as 10˜20 g in one-time water supply (e.g., water can be supplied around five times), and the water supply amount of the extracting step may be set as 35˜60 g in one-time water supply (e.g., extraction of around two times is possible), but the present disclosure is not limited thereto.

In this configuration, the larger the weight of coffee beans, the larger the water supply amount can be set in each step, and the smaller the weight of coffee beans, the smaller the water supply amount can be set in each step, and the water supply amount in each step may be set in advance for each weight of coffee beans.

Further, when at least one distance sensor for measuring the height of coffee bean powder received in the dripper 10 is provided, the controller 140 can recognize the height of coffee bean powder from a measured distance.

In this configuration, when at least height adjuster for adjusting the height of the dripper is included in the coffee drip device 100, the controller 140 can adjust the height of the dripper 10 such that the distance between a recognized height and the outlet of the water supplier 110 becomes a preset distance. For example, the height adjuster may actuate a vertical moving member connected with the dripper 10 and attached to the body to move up and down with respect to the body, and for this purpose, the height adjuster may include various actuating units (e.g., a motor, a compressor, etc.).

Further, the controller 140 can set an initial size of a muffin (e.g., a radius, an outer edge, etc.), a maximum water supply radius of the muffin forming step, a minimum water supply radius of the muffin forming step, a standby time (resting time) between the muffin forming step and the blooming step, etc. In this case, the initial size of a muffin, the maximum/minimum water supply radii of the muffin forming step, etc. may be set new every time in accordance with the weight of coffee beans.

Further, the controller 140 can set a standby time between the operations of water supply constituting the blooming step, the maximum number of times of water supply in the blooming step, a standby time until the extracting step is started after the blooming step is ended, an end standby time of the blooming step, a pre-extraction limit of the blooming step, a maximum water supply radius of the blooming step, etc.

Further, the controller 140 can set a minimum water supply radius of the extracting step, a maximum water supply radius of the extracting step, an extraction limit of the extracting step, etc.

The items described above may be set in accordance with user's input or may be set in advance, or may be automatically set in accordance with the weight (amount) of the photographed coffee beans in the dripper 10.

Referring to FIG. 1, the coffee drip device 100 can sequentially perform a muffin forming step S210, a blooming step S220, and an extracting step S230. When a process of continuous dropping of water is defined as one-time water supply, the coffee drip device 100 can perform water supply once or more in each step.

The muffin forming step S210 is a process in which the coffee drip device 100 supplies water to the dripper 10 through the water supplier, thereby forming a muffin composed of (crushed) coffee beans having moisture and bubbles.

In this case, the coffee drip device 100 can recognize the size of the muffin photographed through the camera 130. In this case, the controller 140 can recognize a region including the muffin in an image taken in real time by analyzing the image and can recognize the size (outer edge, radius, etc.), shape, etc. of the recognized region. In detail, the controller 140 can recognize a size by extracting a region including the muffin on the basis of colors. In this case, at least one of the distance between the camera 130 and the dripper 10 or the distance between the camera 130 and the coffee beans is applied to the size of the region of the muffin in the image, whereby an actual size can be calculated. To this end, a preset distance value may be used or a distance sensor may be used.

Alternatively, the coffee drip device 100 may recognize the size, shape, etc. of a muffin by obtaining 3D data of the muffin through a Lidar sensor, etc.

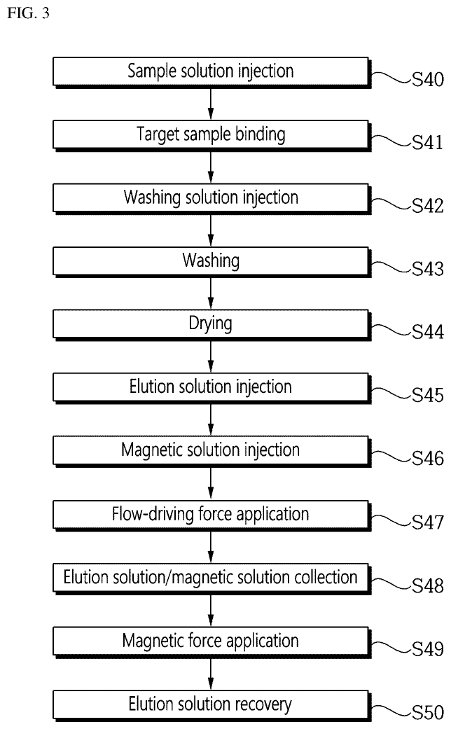

FIG. 3 is an algorithm illustrating a muffin forming step that is performed by a coffee drip device according to an embodiment of the present disclosure.

Referring to FIG. 3, the coffee drip device 100 can supply water to the dripper 10 through the water supplier 110 while spirally changing the water supply point of the water supplier 110 outward from the center through the actuator 120 until the size of a muffin reaches the maximum water supply radius of the muffin forming step (S320—Y) (S310). The maximum water supply radius means the maximum radius of a muffin that enables continuation of water supply, and may have a preset value.

Next, the coffee drip device 100 can supply water to the dripper 10 through the water supplier 110 while spirally changing the water supply point of the water supplier 110 from the outside to the center through the actuator 120 until the size of the muffin reaches the minimum water supply radius of the muffin forming step (S340—Y) (S330). The minimum water supply radius means a minimum radius of a muffin that enables continuation of water supply.

In the way of FIG. 3 described above, the coffee drip device 100 can perform water supply while coming and going to the center and the outer edge of the dripper until a water supply amount set for the muffin forming step is reached.

Further, the coffee drip device 100 can perform the blooming step that secures a resting time when supplying water to the formed muffin (S220 in FIG. 2). A standby time may be given between the muffin forming step and the blooming step.

In detail, the coffee drip device 100 can supply water to the dripper 10 through the water supplier 110 after a predetermined time passes from the point in time at which water supply in the muffin forming step is ended or the point in time at which the height of the muffin is the largest. In this case, the height of the muffin can be sensed by a distance sensor.

In this case, the coffee drip device 100 may set a start position of water supply in accordance with the shape of the muffin. Fundamentally, the controller 140 can set the center point of the dripper 10 as a start position of water supply. However, the start position of water supply may depend on the center of gravity of a muffin. For example, the controller 140 may recognize the center of gravity of a muffin on the basis of the positions (e.g., coordinates) of pixels constituting the region of the muffin and may compare the center of gravity of the muffin with the center point of the dripper 10. When the distance between the center point of the dripper 10 and the center of gravity of a muffin is less than a critical distance, the controller 140 can set the center point of the dripper 10 as a start point of water supply. However, when the center of gravity of a muffin is far from the center point of the dripper 10 over the critical distance, the controller 140 can set at least one point on the straight path from the center point of the dripper 10 to the center of gravity of the muffin as a start point of water supply. As a detailed example, a point corresponding to a half of the straight path connecting the center point of the dripper 10 and the center of gravity of a muffin may be set as a start point of water supply, but the present disclosure is not limited thereto. Meanwhile, a start point of water supply may be flexibly set in accordance with the real-time position difference between the center of gravity of the muffin and the center point of the dripper 10 also in the following steps (e.g., S220 to S240).

Further, the coffee drip device 100 can set a path through which water sequentially drops on the basis of the shape of a muffin photographed through the camera 130. Further, the coffee drip device 100 can supply water to the dripper 10 through the water supplier 110 while changing the water supply point of the water supplier 110 along the set path through the actuator 120.

In detail, the controller 140 can set a water supply path such that a water supply position is changed within a radius not departing from the outer edge of a muffin.

In relation to this matter, the controller 140 can determine whether the shape of a muffin is a circle. In this case, the controller 140 can determine whether the shape of a muffin is a circle by analyzing an image including the region of the muffin. In detail, the controller 130 can select a plurality of points constituting the outer edge of the region of a muffin in an image. In this case, the plurality of points may be points uniformly distributed on a curve forming the outer edge of the muffin (e.g., distances (on the curve) between the points connected to each other along a curve are uniform). In this case, the controller 140 can recognize the shape of the muffin from the distance differences from the center of the dripper 10 to the points constituting the outer edge of the muffin. For example, when the distance differences to the points are less than a predetermined difference, the shape of the muffin can be recognized as a circle. On the contrary, when the distance differences to the points are over a predetermined distance, the controller 140 can determine that the shape of the muffin is not a circle.

For example, when the shape of the muffin is a circle, the controller 140 can calculate the average distance from the center of the dripper 10 to a plurality of points constituting the outer edge of the muffin, and can set a first target radius shorter than the average distance by a predetermined distance (e.g., 1 cm). As a result, the controller 140 performs water supply while spirally changing the water supply point outward from the center, and can keep performing water supply only within the first target radius such that the water supply point no more goes away from the center of the dripper 10 from the point in time at which the position of the water supply point reaches the first target radius.

Further, there may be a case in which the shape of a muffin is not a circle. This corresponds to the case in which a side of a muffin is crushed, water blows out and a filter paper gets wet, or the edge (outer edge) of a muffin is uneven. When it is determined that the shape of the muffin is not a circle, as described above, the controller 140 can select a predetermined number of points, which are close to the center of the dripper 10, from a plurality of points constituting the outer edge of the muffin and can calculate the average distance from the center point of the dripper 10 to the selected points. In this case, the controller 140 can set a second target radius shorter than the calculated average distance by a predetermined distance (e.g., 1 cm). As a result, the controller 140 performs water supply while spirally changing the water supply point outward from the center, and can keep performing water supply only within the second target radius such that the water supply point no more goes away from the center of the dripper 10, from the point in time at which the position of the water supply point reaches the second target radius. As a result, the shape of the muffin that is not a circle can be gradually corrected into a circle. As a detailed example, when a muffin has a shape close to an ellipse and water is supplied only within a radius smaller than the short axis of the ellipse, as a result, the muffin close to an ellipse can gradually become close to a circle.

In this case, the controller 140 can recognize the shape of the muffin in real time and the second target radius can be continuously updated until the shape of the muffin becomes close to a circle (e.g., a water supply radius (water supply path) may be gradually increased outward, as the shape of the muffin becomes close to a circle). Further, when it is determined that the shape of the muffin finally becomes a circle, a first target radius can be set in accordance with the method described above and water supply can be performed within the first target radius.

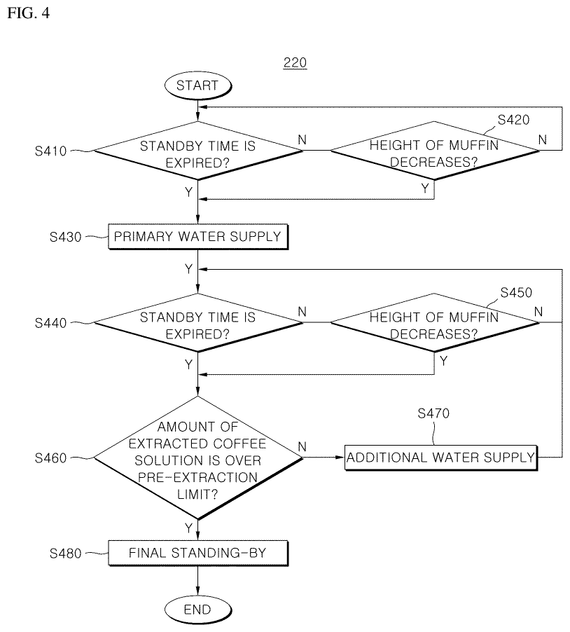

In relation to this matter, FIG. 4 is an algorithm illustrating a blooming step that is performed by a coffee drip device according to an embodiment of the present disclosure.

Referring to FIG. 4, the coffee drip device 100 can start primary water supply from the point in time at which a standby time (e.g., 30 seconds) passes from the end point in time of water supply in the muffin forming step (S410—Y), or from the point in time at which the height of a muffin starts to decrease (S420—Y) (S430).

In detail, the coffee drip device 100 can spirally supplying water outward from the center (e.g., which may be performed within the first/second target radii described above), and can perform water supply back from the outside to the center when the maximum water supply radius of the blooming step is reached. Water supply by the coffee drip device 100 may be ended at the center of a muffin or at the center of the dripper 10.

Additional water supply can be performed from the point in time at which a standby time passes (S410—Y) or the height of the muffin starts to decrease (S420—Y) after the primary water supply.

In detail, when the amount of a coffee solution extracted as the result of the previous primary water supply is less than a preset pre-extraction limit (S460—N), secondary water supply is performed (S470). The amount of an extracted coffee solution can be obtained by measuring the weight of the server 40. To this end, the coffee drip device 100 may include a weight sensor for measuring variation of weight of the server 40.

However, when the amount of a coffee solution extracted as the result of the previous primary water supply is equal to or more than the preset pre-extraction limit (S460—Y), the primary water supply becomes final water supply and final blooming can be performed in accordance with final standing-by (S480).

When secondary water supply is performed, similarly, the amount of a coffee solution extracted as the result up to the second water supply can be compared again with the pre-extraction limit, and when the amount of a coffee solution extracted up to this moment is equal to or more than the pre-extraction limit (S460—Y), the blooming step is ended after the final standing-by (S480) without additional water supply, and when the amount is still less than the pre-extraction limit (S460—N), additional water supply (third water supply) can be performed (S470).

As described above, in the blooming step, water supply can be performed with predetermined standby times (e.g., 20 seconds) until the amount of an extracted coffee solution exceeds the pre-extraction limit, and when the amount of an extracted coffee solution exceeds the pre-extraction limit, the blooming step is ended.

Meanwhile, when there is an extracted coffee solution, for example, the weight of the server 40 changes due to primary water supply in the blooming step, the standby time between the operations of water supply or the water supply amount of each water supply may be set again in the blooming step. When a coffee solution is immediately extracted with primary water supply, it means that pre-extraction of a coffee solution is slightly early, so, in this case, the standby time between the operations of water supply may be increased or the water supply amount may be set lower, but the present disclosure is not limited thereto.

After the blooming step, the coffee drip device 100 can perform the extracting step S230 for extracting a coffee solution.

In detail, the coffee drip device 100 can supply water to the dripper 10 through the water supplier 110 at the point in time after a predetermined time from the point in time at which water supply in the blooming step is ended or at the point in time at which the height of the muffin starts to decrease after the blooming step.

In this case, when the water supply amount from the water supplier 110 reaches a preset water supply amount in the extracting step, the coffee drip device 100 can stop water supply.

Further, when the amount of a coffee solution received in the server 40 reaches an extraction limit in the extracting step, also, water supply can be stopped.

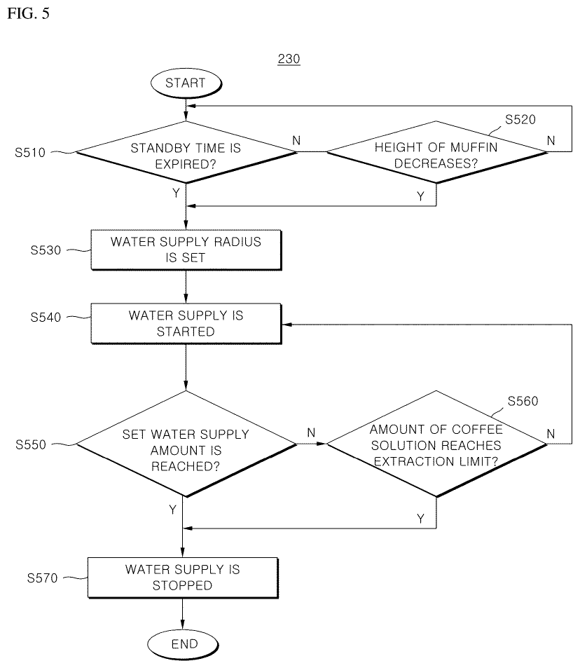

In relation to this matter, FIG. 5 is an algorithm illustrating an extracting step that is performed by a coffee drip device according to an embodiment of the present disclosure.

Referring to FIG. 5, the coffee drip device 100 can start water supply for primary extraction from the point in time at which a standby time passes from the end point in time of water supply in the blooming step (S510—Y), or from the point in time at which the height of the muffin starts to decreases (S520—Y).

In this case, the coffee drip device 100 can set a water supply radius for the extracting step on the basis of the size of the muffin after the blooming step (S530). In detail, a maximum water supply radius and a minimum water supply radius of the extracting step can be set.

Further, water supply for primary extraction can be started (S540). In this case, the coffee drip device 100 can supply water to the dripper 10 while spirally changing the water supply point outward from the center until the size of the muffin reaches the maximum water supply radius of the extracting step, and then, can supply water to the dripper 10 while spirally changing the water supply point from the outside to the center until the size of the muffin reaches the minimum water supply radius of the extracting step.

However, when the water supply amount of the extracting step does not reach a preset water supply amount (S550—N) and the amount of an extracted coffee solution does not reach an extraction limit (S560—N), secondary extraction by additional water supply (secondary water supply) can be performed. In this case, a predetermined standby time can be secured between water supply for primary extraction and water supply for secondary extraction (when there is third water supply, it is the same for between the secondary and the third water supply).

This process can be repeated until the total water supply amount in the extracting step reaches the preset water supply amount (S550—Y) or the amount of an extracted coffee solution reaches the preset extraction limit (S560—Y), and when at least one of the conditions of the steps S550 and S560 is satisfied, water supply can be stopped (S570) and the extracting step can be ended.

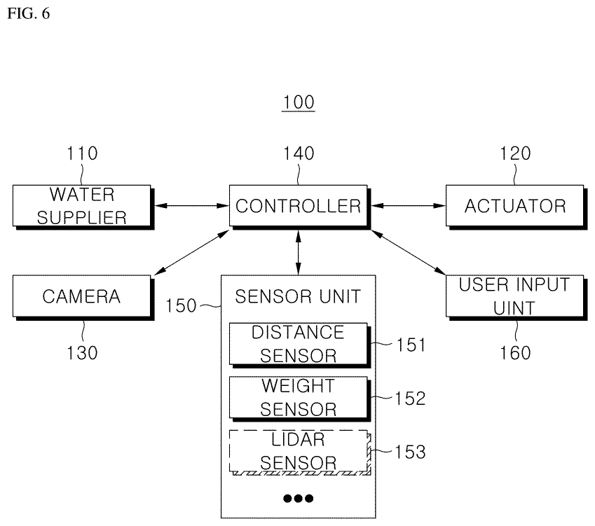

Meanwhile, FIG. 6 is a block diagram illustrating the detailed configuration of a coffee drip device according to various embodiments of the present disclosure.

Referring to FIG. 6, the coffee drip device 100 may include a sensor unit 150, and user input unit 160, etc., in addition to a water supplier 110, an actuator 120, a camera 130, and a controller 140.

The sensor unit 150 is a component for obtaining various items of information relating to coffee bean powder received in the dripper 10, a coffee solution received in the server 40, etc.

The sensor unit 150 may include a distance sensor 151, a weight sensor 152, etc.

The distance sensor 151 is a component for recognizing the height of coffee bean powder by measuring the distance between the outlet of the water supplier 110 and the coffee bean powder in the dripper 10. The distance sensor 151 may be a Time of Flight (ToF) sensor that emits light and measures a distance on the basis of an arrival point in time of reflective light, but is not limited thereto.

The weight sensor 152 is a component for sensing the weight of coffee bean powder received in the dripper 10, the weight of the server 40, etc. To this end, the weight sensor 152 may be installed on at least one structure that supports the dripper 10 and may be installed also on the bed 40 that supports the server 40. For example, the controller 140 can calculate the weight of an extracted coffee solution by sensing variation of weight of the server 40.

The Lidar sensor 153 is a component for obtaining 3D data relating to the shape/size of coffee bean powder in the dripper 10 and 3D data relating to the shape/size of a muffin in the dripper 10. The drip device 100 can recognize the shape/size of a muffin through the camera 130 and/or the Lidar sensor 153.

The user input unit 160 is a component for receiving various user's input/instructions. The user input unit 160 may include one or more buttons, a touch pad, a microphone, a camera, other levers, etc. In detail, the coffee drip device 100 can perform initial setting before the process shown in FIG. 2 is performed, in accordance with a user's instruction. Further, the coffee drip device 100 can perform the process shown in FIG. 2 in accordance with a user's instruction that requests dripping.

Meanwhile, two or more of the various embodiments described above may be combined together unless they conflict or contradict to each other.

Meanwhile, various embodiments described above may be implemented in a recording medium that can be read through a computer or devices similar to the computer, using software, hardware, or a combination of them.

According to hardware-based implementation, embodiments described herein can be achieved by at least one of Application Specific Integrated Circuits (ASICs), Digital Signal Processors (DPSs), Digital Signal Processing Devices (DSPDs), Programmable Logic Devices (PLDs), Field Programmable Gate Arrays (FPGAs), processors, controllers, micro-controllers, microprocessors, and other electric units for performing functions.

In some cases, embodiments described herein may be implemented as a processor. According to software-based implementation, embodiments such as processes and functions described in this specification may be implemented as specific software modules. Each of the software modules described above can perform one or more functions and operations described herein.

Meanwhile, computer instructions or computer programs for performing processing operations in electronic devices such as a robot and a server according to various embodiments of the present disclosure described above may be stored in a non-transitory computer-readable medium. Computer instructions or computer programs stored in such a non-transitory computer-readable medium make a specific device perform processing operations in electronic devices according to various embodiments described above when they are executed by the processor of the specific device.

The non-transitory computer-readable medium is not a medium that stores data for a short time such as a cache and a memory, but a medium that can semipermanently store data and can be read out by a device. As detailed examples of the non-transitory computer-readable medium, there may be a CD, a DVD, a hard disk, a Blu-ray disc, a USB, a memory card, a ROM, etc.

Although exemplary embodiments of the present disclosure were illustrated and described above, the present disclosure is not limited to the specific exemplary embodiments and may be modified in various ways by those skilled in the art without departing from the scope of the present disclosure described in claims, and the modified examples should not be construed independently from the spirit of the scope of the present disclosure.

What is claimed is:

1. A coffee drip device comprising:
a water supplier configured to supply water to a dripper in which crushed coffee beans are received;
an actuator configured to adjust a position of at least a portion of the water supplier such that a water supply point of the water supplier is changed;
a camera configured to take a picture of at least a portion of coffee beans received in the dripper; and
a controller connected with the water supplier, the actuator, and the camera,
wherein the controller
performs a muffin forming step of forming a muffin composed of coffee beans having moisture and bubbles by supplying water to the dripper through the water supplier, and
recognizes a size of the muffin photographed through the camera, and
the controller, in the muffin forming step, supplies water to the dripper through the water supplier while spirally changing the water supply point of the water supplier outward from a center through the actuator until the size of the muffin reaches a maximum water supply radius of the muffin forming step.

2. The coffee drip device of claim 1, wherein, in the muffin forming step, the controller
supplies water to the dripper through the water supplier while spirally changing the water supply point of the water supplier outward from the center through the actuator until the size of the muffin reaches a maximum water supply radius set in advance for the muffin forming step, and
supplies water to the dripper through the water supplier while spirally changing the water supply point of the water supplier from the outside to the center through the actuator until the size of the muffin reaches a minimum water supply radius set in advance for the muffin forming step.

3. The coffee drip machine of claim 1, comprising a distance sensor configured to measure a height of the muffin,
wherein the controller performs a blooming step of securing a resting time of water supply for the formed muffin after the muffin forming step, and
the controller, in the blooming step, supplies water to the dripper through the water supplier after a predetermined time passes from a point in time at which water supply is ended in the muffin forming step or a point in time at which the height of the muffin is the largest.

4. The coffee drip device of claim 3, wherein, in the blooming step, the controller
sets a path through which water sequentially drops on the basis of the shape of the muffin photographed through the camera, and
supplies water to the dripper through the water supplier while changing the water supply point of the water supplier along the set path through the actuator.

5. The coffee drip device of claim 3, comprising a weight sensor configured to measure weight of a server configured to receive a coffee solution extracted through the dripper;
the controller recognizes the amount of the coffee solution received in the server on the basis of the measured weight of the server, and
the controller, in the blooming step,
performs final standing-by of the blooming step when the amount of the coffee solution received in the server increases over a preset pre-extraction limit by primary water supply,
performs secondary water supply after standing by for a predetermined time when the amount of the coffee solution received in the server increases below the preset pre-extraction limit by the primary water supply, and
performs the final standing-by of the blooming step when the amount of the coffee solution received in the server increases over the preset pre-extraction limit by the secondary water supply.

6. The coffee drip device of claim 3, wherein the controller performs an extracting step for extracting a coffee solution after the blooming step; and,
the controller, in the extracting step, supplies water to the dripper through the water supplier at a point in time after a predetermined time from a point in time at which water supply is ended in the blooming step, or at a point in time at which the height of the muffin starts to decrease after the blooming step.

7. The coffee drip device of claim 6, wherein the controller sets a maximum water supply radius and a minimum water supply radius of the extracting step on the basis of the size of the muffin after the blooming step; and,
the controller, in the extracting step,
supplies water to the dripper through the water supplier while spirally changing the water supply point of the water supplier outward from the center through the actuator until the size of the muffin reaches the maximum water supply radius of the extracting step, and
supplies water to the dripper through the water supplier while spirally changing the water supply point of the water supplier from the outside to the center through the actuator until the size of the muffin reaches the minimum water supply radius of the extracting step.

8. The coffee drip device of claim 7, wherein the controller stops water supply when a water supply amount of the water supplier reaches a preset water supply amount in the extracting step.

9. The coffee drip device of claim 7, comprising a weight sensor configured to measure weight of a server configured to receive a coffee solution extracted through the dripper;
wherein the controller recognizes the amount of the coffee solution received in the server on the basis of the measured weight of the server; and
the controller stops water supply when the amount of the coffee solution received in the server reaches an extraction limit in the extracting step.

10. A method of controlling a coffee drip device comprising water supplier configured to supply water to a dripper in which crushed coffee beans are received, an actuator configured to adjust a position of at least a portion of the water supplier such that a water supply point of the water supplier is changed, and a camera configured to take a picture of at least a portion of coffee beans received in the dripper, the method comprising:
a muffin forming step of forming a muffin composed of coffee beans having moisture and bubbles by supplying water to the dripper through the water supplier by means of the coffee drip device;
a blooming step of securing a resting time of water supply for the formed muffin by means of the coffee drip device; and
an extracting step of extracting a coffee solution after the blooming step,
wherein the muffin forming step
recognizes a size of the muffin photographed through the camera, and
supplies water to the dripper through the water supplier while spirally changing the water supply point of the water supplier outward from a center through the actuator until the size of the muffin reaches a maximum water supply radius set in advance for the muffin forming step.

11. A coffee drip device comprising:
a water supplier configured to supply water to a dripper in which crushed coffee beans are received;
an actuator configured to adjust a position of at least a portion of the water supplier such that a water supply point of the water supplier is changed;
a sensor unit configured to obtain sensing data about at least one of a distance, a position, and a shape of at least a portion of the coffee beans received in the dripper; and
a controller connected with the water supplier, the actuator, and the sensor unit,
wherein the controller
performs a muffin forming step of forming a muffin composed of coffee beans having moisture and bubbles by supplying water to the dripper through the water supplier, and
recognizes a size of the muffin on the basis of the sensing data, and
the controller, in the muffin forming step, supplies water to the dripper through the water supplier while spirally changing the water supply point of the water supplier outward from a center through the actuator until the size of the muffin reaches a maximum water supply radius set in advance for the muffin forming step.
